(19) United States
(12) Patent Application Publication
(10) Pub. No.: US 2013/0186024 A1
(43) Pub. Date: Jul. 25, 2013

(54) FIBER COMPOSITE CORNER BEAD

(71) Applicants: Terry L. Rosentiel, Vernon Hills, IL (US); Salvatore C. Immordino, JR., Trevor, WI (US); Guy L. Rosenthal, Wheaton, IL (US); Daniel Eugene Boss, Murphy, TX (US); Joseph Z. Wascow, Vernon Hills, IL (US); Brian Retzke, Downers Grove, IL (US); Steve Oshgan, Des Plaines, IL (US); Nick Jackson, Carol Stream, IL (US); Mark Miklosz, Western Springs, IL (US)

(72) Inventors: Terry L. Rosentiel, Vernon Hills, IL (US); Salvatore C. Immordino, JR., Trevor, WI (US); Guy L. Rosenthal, Wheaton, IL (US); Daniel Eugene Boss, Murphy, TX (US); Joseph Z. Wascow, Vernon Hills, IL (US); Brian Retzke, Downers Grove, IL (US); Steve Oshgan, Des Plaines, IL (US); Nick Jackson, Carol Stream, IL (US); Mark Miklosz, Western Springs, IL (US)

(21) Appl. No.: 13/357,919

(22) Filed: Jan. 25, 2012

(51) Int. Cl. E04F 13/06; B27N 5/00

(52) U.S. Cl. 52/255; 264/257

(57) ABSTRACT

A preformed corner bead for use in wallboard construction is provided and includes an elongate strip formed of a web of at least one layer of non-woven fabric, a resin impregnating the strip. The impregnated strip is formed into a desired angle defined by a pair of flanges prior to a curing of the resin.

### BACKGROUND

The present application relates generally to wallboard construction techniques and materials, and more specifically to corner bead used to form durable, aesthetically pleasing corners at the junction of adjacent wallboard panels in the course of interior construction.

In wallboard construction, a joint or seam formed by adjacent wallboard panels is typically finished using paper or fiber tape extending lengthwise along the joint. Wallboard joint compound is then applied to the tape and feathered or smoothed. When dry, the joint compound is sanded and reapplied as necessary to form a smooth, seam-free joint. To finish exterior corners, metal or plastic corner beads are typically installed. In many applications, the metal bead is somehow fastened to the corner with fasteners or chemical adhesive. Corner bead is also used in some applications for protecting inside (concave) corners.

Corner bead is traditionally manufactured by bending a strip of steel to a 90 degree angle and cutting the strips to lengths of 8-12 feet. The finishing contractor then cuts the strip to the desired length corresponding to the height of the wall, and attaches the bead with nails or screws. The metal corner bead, while durable, relatively rigid, and defining a sharp corner, does not adhere well to wallboard joint compound, presenting problems with cracking and flaking of the finished surface. Due to this characteristic, corners finished with metal corners are relatively difficult to repair when subjected to impact damage. Another drawback of metal bead is that the strips are easily bent or damaged during transportation to the job site, and/or during the cutting or trimming operations prior to application to the wall. In some cases, metal corner beads have experienced rusting, which naturally detracts from the appearance of the finished job.

In recent years, products have been introduced to facilitate the application of corner beads. However, in most cases, such improvements are sold at a price premium relative to “bare metal” beads. Paper faced bead, also known as “paper bead”, and plastic bead can be affixed to the wall without metal fasteners and the plastic product is lighter in weight, corrosion resistant, and more forgiving of bending and impact before the material is installed on the wall. Many such products are provided with paper flanges or “wings” which facilitate their application to wallboard. However their higher cost has prevented broad commercial acceptance of non-metal corner beads.

### SUMMARY

The above-listed drawbacks are met or exceeded by the present corner bead product, which features many of the advantages of conventional non-metal corner bead, at a much lower cost, and one that is comparable to bare metal bead. In a first embodiment, the present bead is made by impregnating a strip of porous, non-woven web-like material such as paper or synthetic non-woven fabric. A curable resin is used to impregnate the web, and the strip is then formed into a desired angle, such as 90 degrees before the resin is cured. Multiple layers of resin-impregnated web are laminated together for added strength.

In another embodiment, layers of web material such as paper or non-woven fabric are secured together, as by chemical adhesive, and formed into a desired angle, such as 90 degrees prior to the adhesive drying. Regardless of the embodiment, upon assembly, the present strip is easily affixed to wallboard panels using joint compound accompanied by fasteners such as nails or screws, and is finished to form a durable and aesthetically pleasing corner. The present product is considered to be cost competitive with metal bead, is readily adhered to the wallboard corner using conventional joint compound, and forms a relatively durable and aesthetically pleasing corner.

More specifically, a preformed corner bead for use in wallboard construction is provided and includes an elongate strip formed of a web of at least one layer of non-woven fabric, and a resin impregnates the strip. The impregnated strip is formed into a desired angle defined by a pair of flanges prior to a curing of the resin.

In an alternate embodiment, a preformed corner bead for use in wallboard construction is provided and includes an elongate strip formed of a web of a plurality of layers of non-woven fabric, each layer having a greater width when viewed from top to bottom. A resin impregnates the strip, and the impregnated strip is formed into a desired angle defined by a pair of flanges prior to a curing of the resin. In addition, a layer of mesh projects from a free edge of at least one of the flanges.

In another embodiment, a method of producing a preformed non-metallic corner bead for wallboard construction is provided and includes providing an elongate strip formed of a web of at least one layer of non-woven fabric; impregnating the strip with a resin; forming the impregnated strip into a desired angle defined by a pair of flanges prior to a curing of the resin; and curing the resin.

### BRIEF DESCRIPTION OF THE DRAWINGS

FIG. 1 is a fragmentary top perspective view of the present corner bead disposed on a wallboard corner;

FIG. 2 is a fragmentary perspective view of another embodiment of the present corner bead;

FIG. 3 is a front view of the bead of FIG. 2;

FIG. 4 is a side elevation of the bead of FIG. 2;

FIG. 5 is a schematic top view of the bead of FIG. 5;

FIG. 6 is a fragmentary top perspective view of another alternate embodiment of the present corner bead;

FIG. 7 is a top perspective of a mold fixture suitable for producing the present corner bead; and

FIG. 8 is a fragmentary exploded top perspective view of the mold fixture of FIG. 7.

### DETAILED DESCRIPTION

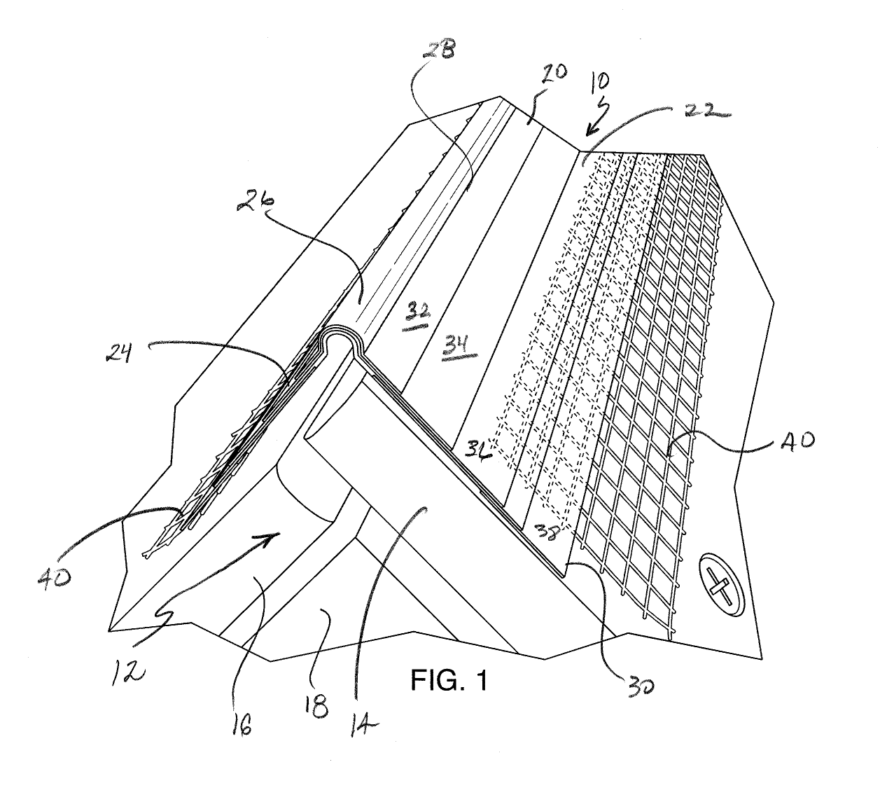

Referring now to FIG. 1, the present corner bead, generally designated 10, is shown installed upon a wallboard corner 12, formed from an approximate 90° intersection of adjacent edges of two wallboard panels, 14 and 16. As is known in the art, the panels 14, 16 are secured by fasteners to a framing member 18, typically made of wood or metal. The procedure for attaching the wallboard panel 14, 16 is well known in the art to skilled practitioners. Application of the present corner bead 10 is desired to produce a finished wall that can be readily painted. As is known in the art, the corner bead 10 is secured to the corner 12 using wallboard joint compound and fasteners such as screws or nails.

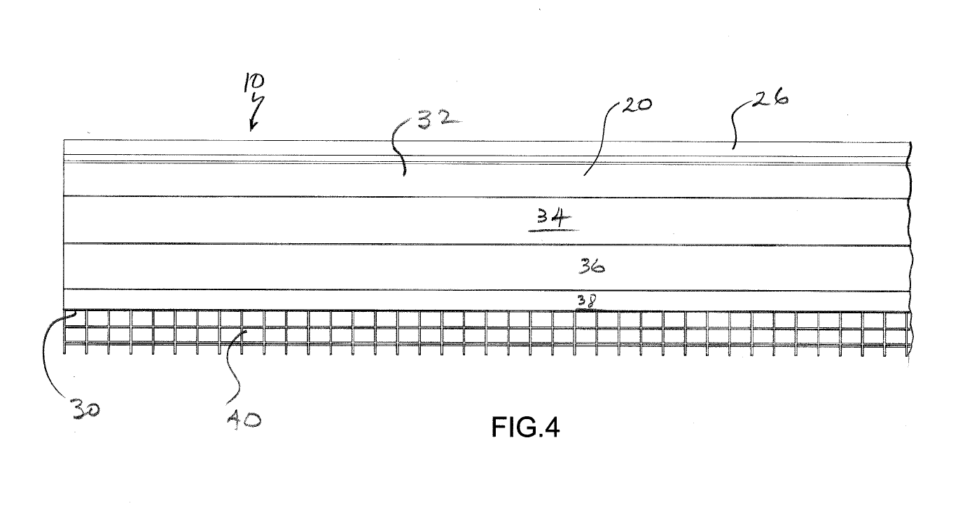

Referring now to FIGS. 1-4, in general, the present corner bead 10 is formed into an elongate strip 20 formed of a web of at least one layer of non-woven fabric, which is then impregnated with a resin and shaped to form a corner, typically at approximately 80-90° or other desired angle. Upon curing of the resin, a self-supporting, generally rigid corner bead is obtained. The strip 20 can then be readily cut to a desired length as required by the application.

More specifically, the present elongate strip 20 is formed of cellulosic paper commonly used to make wallboard joint tape. A preferred type of such tape is USG Sheetrock® brand Joint Tape sold by United States Gypsum Company, Chicago, Ill. Other suitable fabric or paper base materials for the strip 20 are contemplated. One such alternative is porous fabric of non-woven polyester fibers held together with resin binder. The preferred paper forming the strip 20 has sufficient stiffness to be self-supporting upon curing, satisfactory porosity for accommodating a resin, and a preferred thickness of a single layer is in the range of 0.18-0.23 mm (0.007-0.009 inch). While other dimensions are contemplated, a preferred width of the elongate strip 20 is 38.10-76.20 mm (1.5-3.0 inch). A suitable paper is formed into a pair of flanges 22, 24 which preferably define a corner rib 26 along common edges 28. Preferably planar, the flanges 22, 24 each have a free edge 30 opposite the corner rib 26.

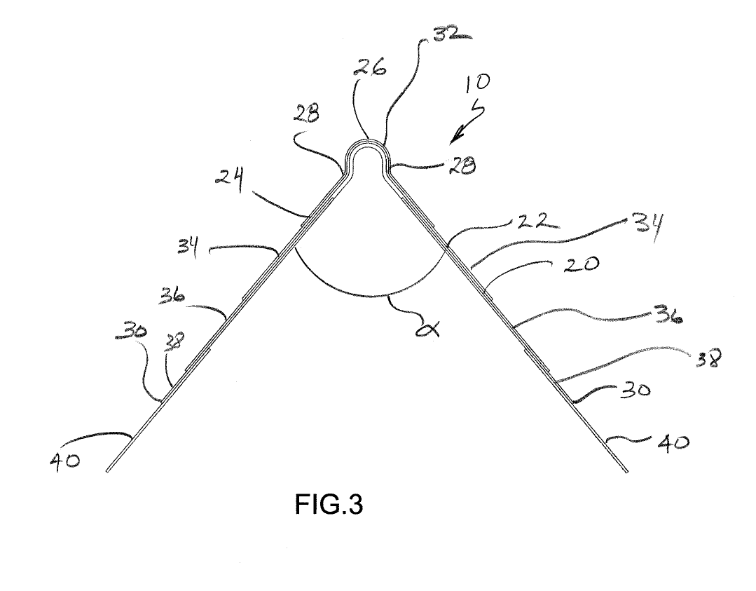

The impregnated elongate strip 20 is formed into a desired angle a (FIG. 3) defined by the flanges 22, 24 prior to a curing of the resin. While other angles are contemplated, in the preferred embodiment, α is approximately 80°. Since the angle a is less than 90°, the bead 10 will exert an inherent clamping force on the wallboard corner 12 to facilitate adhesion.

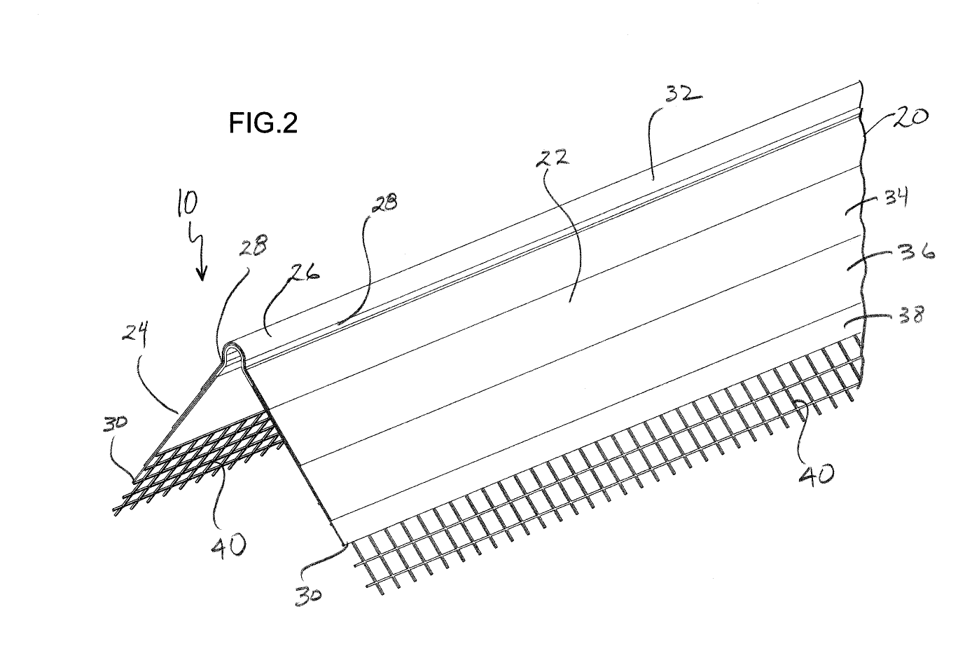

As is known in the corner bead art, since such structure is provided on conventional metal corner beads, the corner rib 26 is integrally formed from the strip 20, and defines a hollow, generally “U”-shape, other arcuate or semicircular shape when viewed in cross section (best seen in FIGS. 2 and 3). Corner ribs 26 are used for absorbing shock impact, and for creating a raised edge for facilitating the application of a relatively thicker layer or wallboard joint compound used to finish the joint.

A suitable resin used to impregnate the elongate strip 20 is chosen from several types, including polyester, acrylic, epoxy or polyurethane. A preferred resin is Bondo® resin sold by 3M Corporation, and another suitable resin is polyvinyl acetate (PVA). The amount of resin ranges from 1.6-16.6 grams/meter (0.5-5 grams/foot) of paper having the general width and thickness dimensions described above.

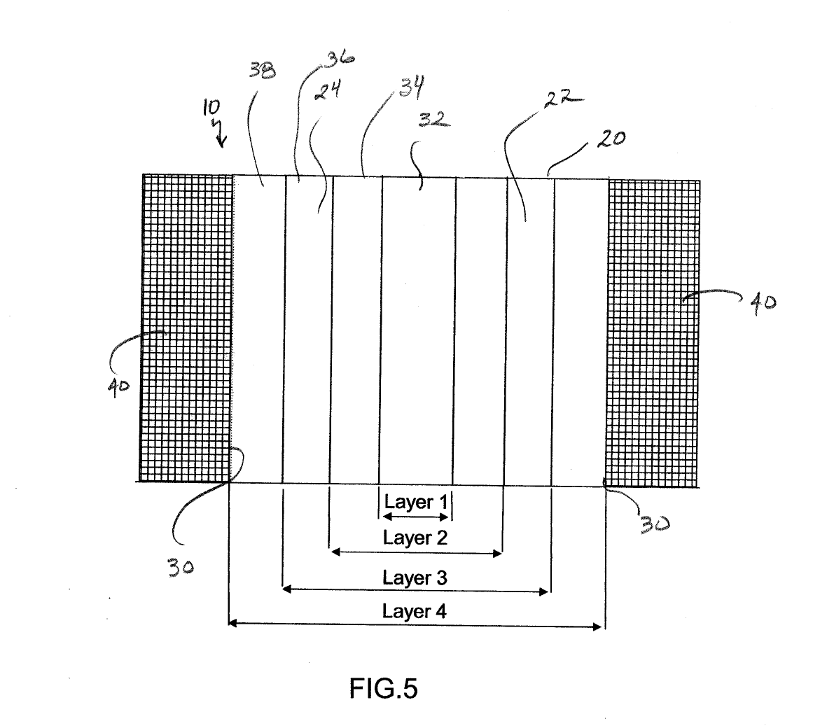

Referring now to FIGS. 2-5, the construction of the elongate strip 20 is discussed in further detail. While a single layer of paper or other material is contemplated, It is preferred that the elongate strip 20 is formed from a plurality of layers 32, 34, 36 and 38 of non-woven fabric. When viewed from top to bottom (as determined by the orientation seen in FIGS. 1-3), the layers 32-38 progressively have a greater width closer to the bottom, and as such form steps on the flanges 22, 24. While the width of the layers 32-38 may vary to suit the application, an example of the composite corner bead 10 is where the top layer 32 has a width of 1.91 cm (0.75 inch), the next or second layer 34 has a width of 3.81 cm (1.5 inch), the next or third layer 36 has a width of 5.23 cm (2.06 inch) and the bottom or fourth layer 38 has a width of 6.35 cm (2.5 inch). In the preferred embodiment, the resin is applied between or upon each layer, 30, 32, 34, and 36.

To further strengthen the bond between the flanges 22, 24 and the adjacent wallboard, an optional layer of open mesh 40 is secured to at least one flange and preferably both flanges so as to project from the free edge 30. In the preferred embodiment, the mesh 40 is an adhesive-backed nylon mesh tape, and is held in place with the adhesive provided on the tape. The mesh 40 is further secured by a layer of resin applied to the tape where it overlaps the flange 22, 24. While several types of mesh tape are suitable, a preferred type is FibaTape® wallboard tape manufactured by Saint Gobain Technical Fabrics, Valley Forge, Pa., USA. The mesh 40 preferably extends approximately 1.27 cm (0.5 inch) past the free edge 30.

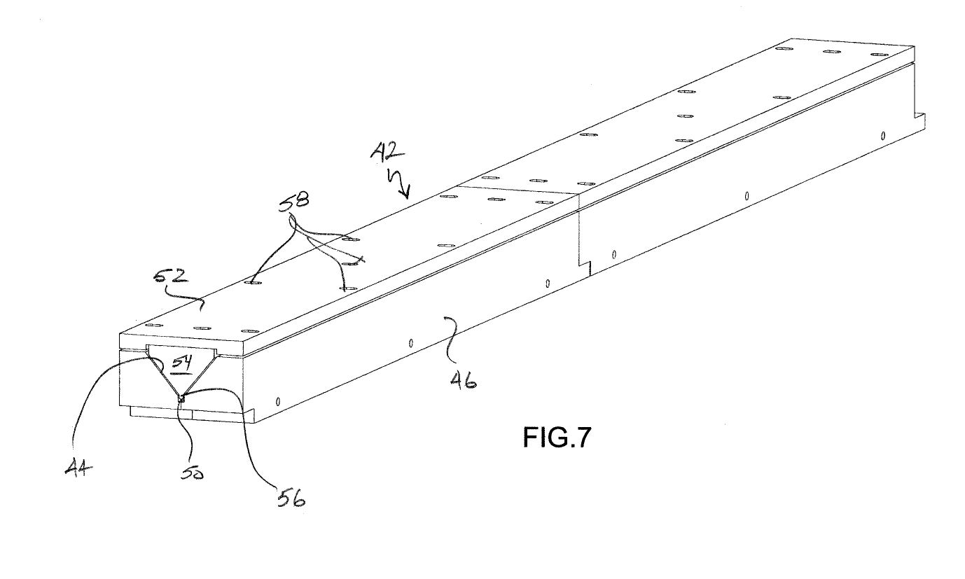

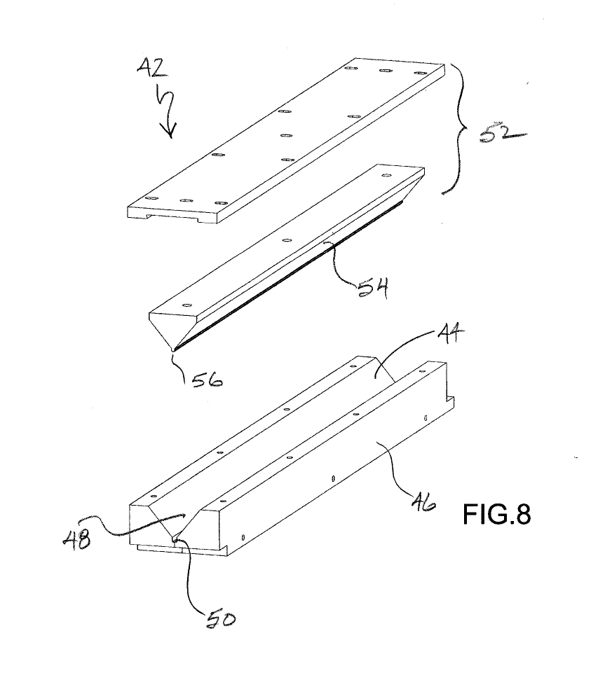

Referring now to FIGS. 7 and 8, a mold fixture, generally designated 42 is provided for facilitating the assembly and fabrication of the corner bead 10. Once the layers 32-38 and the mesh 40 are assembled, they are placed upon an upper surface 44 of a lower portion 46 defining a “V”-shaped cavity 48 which approximates the desired angle a of the ultimate finished corner bead 10. In addition, a trough or groove 50 is formed at the apex of the “V” for forming the corner rib 26. The layers 32-38 are positioned in the cavity 48 so that the flanges 22, 24 are aligned with the walls of the “V.” The resin is optionally applied to the layers 32-38 before they are assembled. Additional resin is applied if the layers 32-38 are not already impregnated when they are placed in the cavity 48.

An upper portion 52 of the fixture 42 has a depending wedge shape 54 including an axially extending, depending projection 56 for forming the corner rib 26. In general, the shape 54 and the projection 56 complement the shape defined by the upper surface 44 and the trough 50 of the lower portion 46. The upper portion 52 is secured to the lower portion 46 with the resin-impregnated layers 32-38 and the optional mesh 40 sandwiched therebetween. At least one fastener such as a threaded screw is inserted into apertures 58 to fasten the portions 46, 52 together to create a compressive clamping force on the layers 32-38 and the mesh 40. Thus, the step of forming includes procedures for configuring the strip(s) of paper 20, once impregnated with resin, to retain the desired angle a.

Next, once the impregnated paper layers 32-38 are formed to the desired shape, the fasteners are removed and the resin in the layers and the optional mesh 40 is cured using light, heat or moisture or combined with a chemical hardener to form a hardened composite, typically within 1 minute. It should be noted that in FIG. 7, the mold fixture is shown in two identical segments, typically approximately 1.22 meters (4 feet) in length which are joined together lengthwise to approximate a typical ceiling height. In FIG. 8, only one of the sections of the fixture 42 is shown exploded, since the sections are identical.

It should be understood that the fixture 42 is a prototype version provided as an example. For mass production, commercial-style molds are contemplated, in which the layers are placed in the mold, resin added, the mold closed, and the resin cured.

Alternately, a continuous feed process is contemplated, where rolls of paper strips are arranged to converge the paper into a multilayer laminate. Just prior to the papers converging, the resin is applied onto or between the layers. Next, the layers are shaped or formed to the desired angle using a roll former, and the formed bead is then cured, such as by heat or UV. The resulting strip is then cut to a desired length.

It is also contemplated that the present corner bead 10 is alternately mass-produced using an extruder, where the paper and resin are mixed into a slurry, which is emitted from the extruder in the desired formed web shape, including the corner rib 26. Curing occurs while the web is held in the desired shape. The curing is also optionally accomplished with UV light, which initiates cross-linking of the resin, as is known in the art.

In another embodiment, instead of the above-identified paper, the layers 32-38 are made of a porous fabric consisting of non-woven polyester fibers held together with a resin binder, also referred to as synthetic paper is impregnated with resin. The impregnated fabric is then formed, compressed and cured as described above. It is also contemplated that a texture may be added to external surfaces of the layers 32-38, as by a roller, to increase adhesion of the wallboard joint compound.

In still another alternate embodiment, 2 strips of paper (cellulosic or synthetic) each 0.18-0.23 mm (0.007-009 inch) thick, and having the same width, are impregnated with resin and pressed together to form a laminate before molding into a corner shape. Layers can be added, and different layers can be laid with different overall fiber orientations to form a stronger laminate, until the overall thickness of the product approaches 0.13 cm (0.050 inch). Above that thickness, forming a smooth finish of the edge of the bead on the wall becomes impractical.

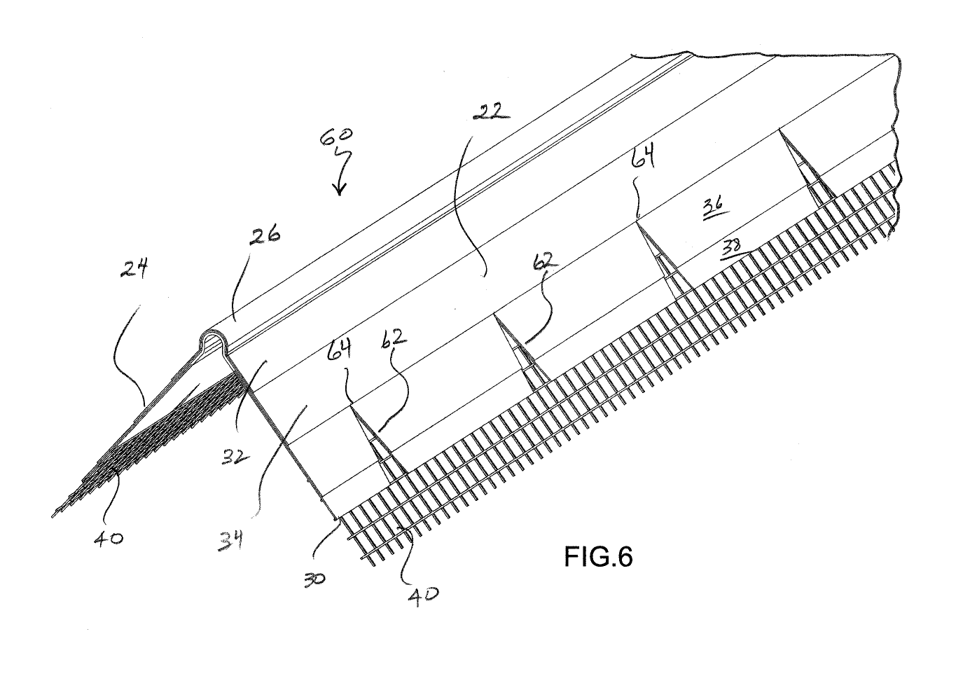

Referring now to FIG. 6, an alternate embodiment of the present corner bead is generally designated 60. Components shared with the bead 10 are designated with identical reference numbers. A main difference between the beads 60 and 10 is that the former is provided with at least one and preferably a plurality of reliefs or slits 62 in the flanges 22, 24. The purpose of these reliefs 62 is to prevent the flanges 22, 24 from buckling during installation, and to provide additional area for the wallboard joint compound to bond with the wallboard. Thus, flange delamination in response to shock impact on the corner is reduced. While in the preferred embodiment, the reliefs 62 are triangular or wedge-shaped, with points 64 of the wedges oriented towards the corner rib 26 and the reliefs generally transverse to an axis defined by the corner rib, it is contemplated that the number and shape of the reliefs may vary to suit the application.

Accordingly, the present corner bead provides a durable, relatively low-cost alternative to conventional metal corner beads. By changing the number of layers, and the dimensions of individual layers, the properties of the bead may be adjusted to suit individual applications. While a particular embodiment of the present fiber composite corner bead has been described herein, it will be appreciated by those skilled in the art that changes and modifications may be made thereto without departing from the invention in its broader aspects and as set forth in the following claims.

What is claimed:

1. A preformed corner bead for use in wallboard construction, comprising:
an elongate strip formed of a web of at least one layer of non-woven fabric;
a resin impregnating said strip; and
said impregnated strip being formed into a desired angle defined by a pair of flanges prior to a curing of said resin.

2. The corner bead of claim 1 wherein said resin is taken from the group consisting of polyester, acrylic, epoxy or polyurethane.

3. The corner bead of claim 1 wherein said elongate strip is formed from a plurality of said layers of non-woven fabric, and when viewed from top to bottom, said layers each having a progressively greater width towards the bottom and as such forming steps on said flanges.

4. The corner bead of claim 1 further including a layer of mesh projecting from a free edge of at least one of said flanges.

5. The corner bead of claim 1 wherein said non-woven fabric is taken from the group consisting of cellulosic paper and porous fabric of non-woven polyester fibers held together with resin binder.

6. The corner bead of claim 1 wherein said resin is cured by at least one of light, heat, moisture and a chemical hardener.

7. The corner bead of claim 1 further including a hollow corner rib formed by adjacent edges of said flanges.

8. The corner bead of claim 7 wherein said corner rib is defined to have a generally “U”-shape in cross-section.

9. A preformed corner bead for use in wallboard construction, comprising:
an elongate strip formed of a web of a plurality of layers of non-woven fabric each said layer having a greater width when viewed from top to bottom;
a resin impregnating said strip;
said impregnated strip being formed into a desired angle defined by a pair of flanges prior to a curing of said resin; and
a layer of mesh projecting from a free edge of at least one of said flanges.

10. The corner bead of claim 9 further including a hollow corner rib formed by adjacent edges of said flanges.

11. The corner bead of claim 10 wherein said corner rib is defined to have a generally “U”-shape in cross-section.

12. A method of producing a preformed, non-metallic corner bead for wallboard construction, comprising:
providing an elongate strip formed of a web of at least one layer of non-woven fabric;
impregnating said strip with a resin;
forming said impregnated strip into a desired angle defined by a pair of flanges prior to a curing of said resin; and
curing said resin.

13. The method of claim 12 wherein said non-woven fabric is taken from the group consisting of cellulosic paper and porous fabric of non-woven polyester fibers held together with resin binder.

14. The method of claim 12 wherein said resin is taken from the group consisting of polyester, acrylic, epoxy or polyurethane.

15. The method of claim 12 wherein said curing step is performed by at least one of light, heat, moisture and a chemical hardener.

16. The method of claim 12 wherein said forming step is performed in a mold fixture.

17. The method of claim 16 wherein said mold fixture has a lower portion defining a “V”-shaped cavity and an upper portion defining a complementary projection for sandwiching said resin-impregnated web therebetween.
